(19) United States
(12) Patent Application Publication
(10) Pub. No.: US 2013/0235380 A1
(43) Pub. Date: Sep. 12, 2013

(54) CALCULATING THE CONCENTRATION OF SOLIDS IN A FLUID

(71) Applicants: Niv Shemtov, Rishon LeZion (IL); Evgeny Plaskov, Nes Ziona (IL); Ziv Gilan, Kfar-Harif (IL); Uri Tovim, Petach Tiqva (IL)

(72) Inventors: Niv Shemtov, Rishon LeZion (IL); Evgeny Plaskov, Nes Ziona (IL); Ziv Gilan, Kfar-Harif (IL); Uri Tovim, Petach Tiqva (IL)

(21) Appl. No.: 13/415,528

(22) Filed: Mar. 8, 2012

(51) Int. Cl. G01N 21/85; G01N 21/59

(52) U.S. Cl. 356/442

(57) ABSTRACT

A system and method to calculate a concentration of solids in a fluid, the system including a light source to generate a light signal of predefined characteristics, a an optical detector, placed opposite the light source across a gap between the light source and the detector through which the fluid may flow and a processor to identify the light signal in a detection signal generated by the optical detector, and to calculate the concentration of solids in the fluid based on the identified light signal as related to the generated light signal.

### BACKGROUND

Densitometers can measure the passage of light through a transparent or semitransparent material. The measured density of a measurable substance is typically determined by measuring attenuation in the intensity of light which reaches the optical detector of the densitometer after passing through the measurable substance, the measurement being related to the absorption of light of the measurable substance.

Most densitometers include a light source, often a laser, aimed at a photoelectric cell, arranged with a gap in between so as to allow placing the measurable substance in the gap. The electric current that is generated by the photovoltaic cell of the densitometer is typically directly proportional to the intensity of the incident light, and thus the density of the measurable substance is determined by comparing the generated current with a reference current value that corresponds to the passing of light from the light source to the photovoltaic cell when the gap is kept empty (e.g. in vacuum).

Densitometers can be either transmission densitometers or reflection densitometers. Transmission densitometry instruments typically measure how transparent a substance is to visible light or other electromagnetic radiation. Reflection densitometry devices measure the amount of reflected visible light or other electromagnetic radiation of a sample. Densitometers are used in many industries as tools to measure the concentration of solids in a liquid of materials, i.e., liquids, and to provide quality assurances of a particular liquid, including foodstuffs, medications, or ink for inkjet printers.

### BRIEF DESCRIPTION OF THE DRAWINGS

Examples are described in the following detailed description and illustrated in the accompanying drawings in which:

FIG. 1a is a schematic illustration of a device for calculating the optical density, and in some examples, the concentration of solids in a fluid, according to an example;

FIG. 2 is a flow chart of a method for calculating the concentration of solids in a liquid of a fluid, according to an example; and,

FIG. 3 is flow chart of a method for calculating the concentration of solids in a liquid of a fluid, according to an example.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the methods and apparatus. However, it will be understood by those skilled in the art that the present methods and apparatus may be practiced without these specific details. In other instances, well-known methods, procedures, and components have not been described in detail so as not to obscure the present methods and apparatus.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

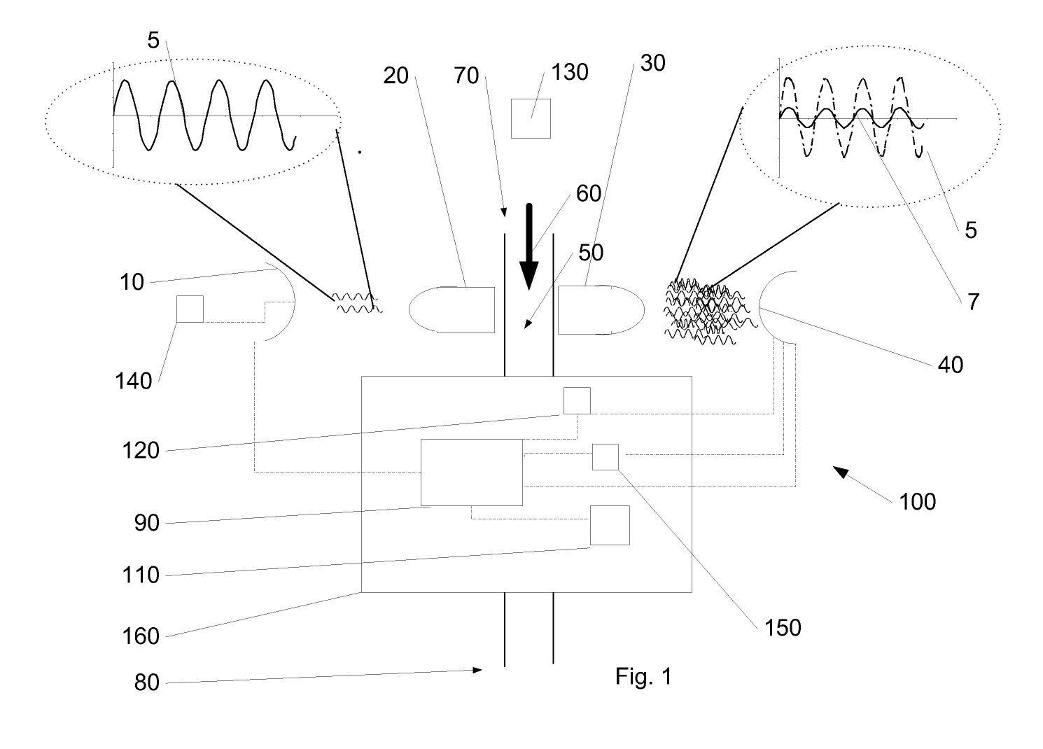

FIG. 1a is a schematic illustration of a device for, in some examples, calculating the concentration of solids in a fluid, according to an example.

A densitometer 100 may typically include a light source 10, a collimating lens 20, a focusing lens 30, and a detector 40. Other lenses as are known in the art may also be employed in addition to, or instead of, lenses 30 and 40, in some examples.

In some examples, detector 40 may be a photodiode. Other detectors that are known in the art may also be employed.

Densitometer 100 may typically be configured to determine the optical density of a fluid 60 passing through a gap 50 between lens 20 and lens 30. Typically, densitometer 100 measures the concentration of solids in a fluid. In some examples, densitometer 100 measures other characteristics of fluids as are known in the art.

In some examples gap 50 may be between light source 10 and detector 40. In some examples, gap 50 may have a set width, the width maintained by a support structure, the support structure configured to maintain the width of the gap to a high degree of tolerance.

In some examples, light source 10 may be configured to transmit a signal 5 through fluid 60 and gap 50. Typically, signal 5 may be a light beam. In some examples, the light beam may be produced by a laser. Other signals known in the art may also be employed by densitometer 100.

In some examples, gap 50 may have a width of a few hundred microns (e.g. about 300 microns, for example, with a tolerance of +/−10 microns). In some examples, gap 50 may have a width less than 300 microns. In some examples, gap 50 may have a width greater than 300 microns.

In some examples, gap 50 may be configured to be positioned between an inlet 70, and an outlet 80, such that the pathway of fluid 60 flowing through gap 50 is substantially perpendicular to the pathway of signal 5 traveling from light source 10 to detector 40. Fluid 60 traveling from inlet 70, through densitometer 100 and continuing, in some examples, through outlet 80.

In some examples, inlet 70 is part of a pathway of ink in a printer; inlet 70 may be connected to an ink reservoir. In some examples, outlet 80 is part of the pathway in a printer, the pathway ending at a printing element of a printer. A hydraulic system 130 may provide a constant ink flow through gap 50 in some examples.

In some examples, inlet 70 and outlet 80 are part of a pathway of a quality assurance system. In further examples, inlet 70 and outlet 80 are part of a pathway in a production line.

In some examples, densitometer 100 may be configured to determine the optical density of fluid 60. In some examples, densitometer 100 may be configured to measure characteristics of fluid 60 that affect the propagation and/or attenuation of light through a fluid, the characteristics, as are known in the art.

In some examples, densitometer 100 may be configured to determine the percentage of solids in a fluid. In some examples, densitometer 100 may be configured to determine the amount of solid particles within fluid 60. In some examples densitometer may be configured to determine the percentage of non-volatile substances (% NVS) in the fluid, such as, for example, % NVS, where the NVS are pigments of a colorant of ink for a printer.

In some examples, densitometer 100 may be configured to determine the % NVS of a range of colorants of ink for a printer with a high dynamic range of optical densities ranging from 0% NVS to 8% NVS, as described below.

In some examples, densitometer 100 may be configured to measure a dynamic range of % NVS from 0% to 8% with a resolution of +/−0.0005% NVS as described below.

In some examples, densitometer 100 may be configured to measure a dynamic range of electronic signals, typically a range of 90 decibel milliwatts (dBm).

Typically, signal 5 may include measurable and/or determinable characteristics and/or properties. These include the frequency of signal 5, the shape of signal 5 and the amplitude of signal 5. In some examples, signal 5 may be describable as a wave function. In some examples, signal 5 may be describable as a sinusoid, i.e., a mathematical function describing a smooth, and in some examples, repetitive oscillation. Other characteristics and/or properties of signals are known in the art and may also be measurable and/or determinable.

In some examples, the detection and analysis of the generated signal 5 through fluid 60 in gap 50 may provide a measurement of the absorbance of signal 5 by fluid 60. In some examples, the detection and analysis of the transmission of light may provide a measurement of the attenuation of signal 5 from light source 10 by traveling through fluid 60.

The attenuation of signal 5 traveling through liquid 60, as signal 5 propagates through the fluid, can provide information regarding the concentration, and in some examples the % NVS value of fluid 60, according to the following equation:

P(x)=P_{τ}·b·e^{[-L·a·x]}

where: P(x) is the received power detect by detector 40;

x is, in some examples, % NVS;

L is, in some examples, the width of gap 50 between lens 30 and 40;

a is, in some examples, an empirical value calculated experimentally with relation to a particular pigment;

P_{T} is, in some examples, the emitted power emitted by light source 10; and,

b is, in some examples, an experimental proportional value.

Typically a look-up table 110 may be provided, to store measured or calculated values of some or all of the above mentioned parameters to be used as reference.

In some examples the attenuation of light may be exponential. In some examples, the light from light source 10 may be attenuated by at least about 10⁻⁴. In some examples, light from light source 10 may be attenuated as it passes through fluid 60 by as much as about 10⁻¹⁹ or more, as is known in the art.

In some examples, light source 10 may be a laser. Typically, the power of the light source 10 may be limited due to limitations inherent in densitometer 100 and, in some examples, limitations inherent in a device to which densitometer 100 is coupled. In some examples, laser power may be limited by nature of the materials used to construct densitometer 100. In some examples, laser power may be limited by the size of the area in which densitometer is configured to placed. In some examples where densitometer is a component of a printing system, laser power may be limited by the materials employed in construction of the printer and the location of densitometer 100 within the printing system.

In some examples, light source 10 may include a laser with a power of between 65 mw to 85 mW, e.g., 70 mW. For example, light source may include a 780 nm 70 mW laser. Other lasers known in the art may also be used.

In some examples, light source 10 may be a laser with a near built-in power detector 140, such that the laser may shift a transmitted signal away from a noisy frequency band in response to a data signal, typically in response to a data signal from a processor 90 as described below.

In some examples there may be one or a plurality of processors 90. Typically, one or more processors 90 are in communication with each other as is known in the art.

In some examples, light source 10 may be a laser configured to maintain a constant optical power. In some examples light source 10 may be able to generate a modulated signal, the properties of said modulated signal may be communicated to processor 90.

In some examples, light source 10 may be configured to provide a signal in the form of a wave. In some examples, light source 10 may be configured to powered on less than 100% of the time that densitometer 100 is powered on. In some examples, the ability of light source 10 to be powered on less than 100% of the time allows light source 10 to have a longer life span.

In some examples, light source 10 may be able to generate a signal that may be locked-in with relation to some properties of the signal, the locked-in the properties of said signal may be communicated to processor 90.

Other light sources that are known in the art may also be employed as well.

In some examples, light source 10 may be a laser more powerful than 70 mW. In some examples, light source 10 may be a laser less powerful than 70 mW.

In some examples, the environment for the transmission of signal 5 from a typically, low powered light source through fluid 60 in gap 50 may be noisy. Typically, noisy refers to signal extraneous to light source 10. In some examples, noise refers to electrical noise, as is known in the art.

In some examples the noise in the environment may be the result of unstable transistors. In some examples the noise in the environment may be the result components in the densitometer. In some examples the noise in the environment may be the result other components coupled to the densitometer. In some examples the noise in the environment may be the result components within a device that also contains densitometer 100. In some examples the noise in the environment may be the result devices external to the device that may contain densitometer 100. In some examples the noise in the environment may be the result of other sources of noise that are known in the art.

In some examples, signal 5 is assimilated in the noisy background and attenuated by fluid 60 such that while initially light source 10 may produce a signal at 70 mW, the detected signal 5 from light source 10 may be only measurable in picowatts by detector 40.

In some examples, densitometer may include a processor 90, e.g., a computer processing unit (CPU). In some examples, processor 90 may be mounted on a circuit board 160.

In some examples, circuit board 160 may be configured to reside between inlet 70 and outlet 80.

Typically, processor 90 may be configured to be in communication with light source 10. In some examples, processor 90 may be configured to control light source 10, such that light source 10 produces signal 5 with predefined characteristics. In some examples, predefined characteristics may include a known wave function or know wave shape with know frequency and amplitude. In some examples, processor 90 may be configured to control light source 10 such that light source 10 produces signal 5 definable as a sine wave with a predefined frequency of one kilohertz.

Typically processor 90 may be in communication with detector 40. In some examples, processor 90 may receive a detected signal form detector 40. Typically, processor 90 may determine the concentration of fluid 60 by analyzing the detected signal from detector 40 and comparing detected signal with the generated signal 5 from light source 10.

In some examples, processor 90 may be configured to determine the predefined wave of signal 5 to be a wave function as known in the art. Typically, processor 90 may be configured to determine the predefined wave of signal 5 to be a sine wave.

Typically, processor 90 may be in communication with detector 40 such that detector 40 is configured to specifically filter out a signal not definable by the sine wave with the known frequency produced by light source 10 from other noise in densitometer 100.

In some examples, processor 90 may be in communication with detector 40 such that detector 40 is configured to specifically filter out a signal not definable by a sine wave with a frequency of one kilohertz, wherein light source 10 produces signal 5 describable as a sine wave with a frequency of one kilohertz.

In some examples, processor 90 may be in communication with detector 40, such that detector 40 is configured to detect signal 5 with a particular sine wave with know frequency and, in some examples, detect changes in amplitude of signal 5.

In some examples, processor 90 may optimize and/or modulate the frequency of signal 5 from light source 10, such that a ratio of signal to noise is changed.

In some examples, detector 40 may include or, in some examples, detector 40 may be in communication with an analog to digital converter 120. Typically, analog digital converter 120 may be coupled to processor 90. The analog to digital converter 120 may be configured such that a dynamic range of attenuated signal from light source 10 may be detected by detector 40 as is known in the art.

Typically, analog to digital converter 120 may have of resolution of 24 bits. Other analog to digital converters as are known in the art may also be used.

Typically, as a generated signal 5 travels through fluid 60 from light source 10 to detector 40, the amplitude of signal 5, signal 5 defined by a particular sine wave at a particular frequency, may change, but typically, the frequency and shape of the sine wave does not.

In some examples, processor 90 may employ an empirically defined look-up table 110 to determine the density of and/or concentration of solids within fluid 60 from the detected signal by detector 40.

Typically, look-up table 110 may contain data relating to the amplitude, frequency and shape of a received signal 7 by detector 40 given the characteristics of fluid 60. In some examples, look-up table contains empirically derived data given the parameters of densitometer 100, the parameters of fluid 60 and/or the parameters of signal 5.

Typically, characteristics of fluid 60 included in look-up table 110 may include the color of fluid 60.

In some examples, a generated signal from light source 10 through fluid 60 may be propagated through fluid 60 and gap 50 and received by detector 40. Typically detector 40 is in a powered on stage wherein some or all signals are detected.

Received signal 7 may be converted into a current by a current to voltage converter 150, in some examples, a transimpedance amplifier. Current to voltage converter 150 may have a selectable gain, the gain selected typically by processor 90, and in some examples, according to data from look-up table 110.

Typically, voltage from current to voltage converter 150 may be filtered by detector 40 such that received signal 7, an attenuated form of signal 5 with known and in some examples, predefined characterizes from light source 10 is detected amongst the noise.

Typically, received signal 7 is sampled by analog to digital converter 120. In some examples, analog to digital converter may have a built-in digital filter configured to improve the dynamic range of detector 40.

In some examples, one manufactory calibration of densitometer 100 may be employed to allow for a wide dynamic range of signal, large signal to noise ratios, and weak signal. In some examples, one or a plurality of manufactory calibrations may be employed. In some examples, the user may be able to calibrate densitometer 100.

In some examples, densitometer 100 is configured to communicate to another system if the detected % NVS of fluid 60 is higher or lower than anticipated or expected. In some examples, densitometer 100 may be configured to communicate to another system if the % NVS of fluid 60 is out of a particular predefined range.

In some examples, densitometer 100 may be configured to communicate to another system if the % NVS of fluid 60 is trending toward an undesired level. In some examples, when the % NVS of fluid 60 is trending toward an undesired level, densitometer 100 may signal another system to change the constitution, e.g., the concentration of solids, of fluid 60 passing through gap 50.

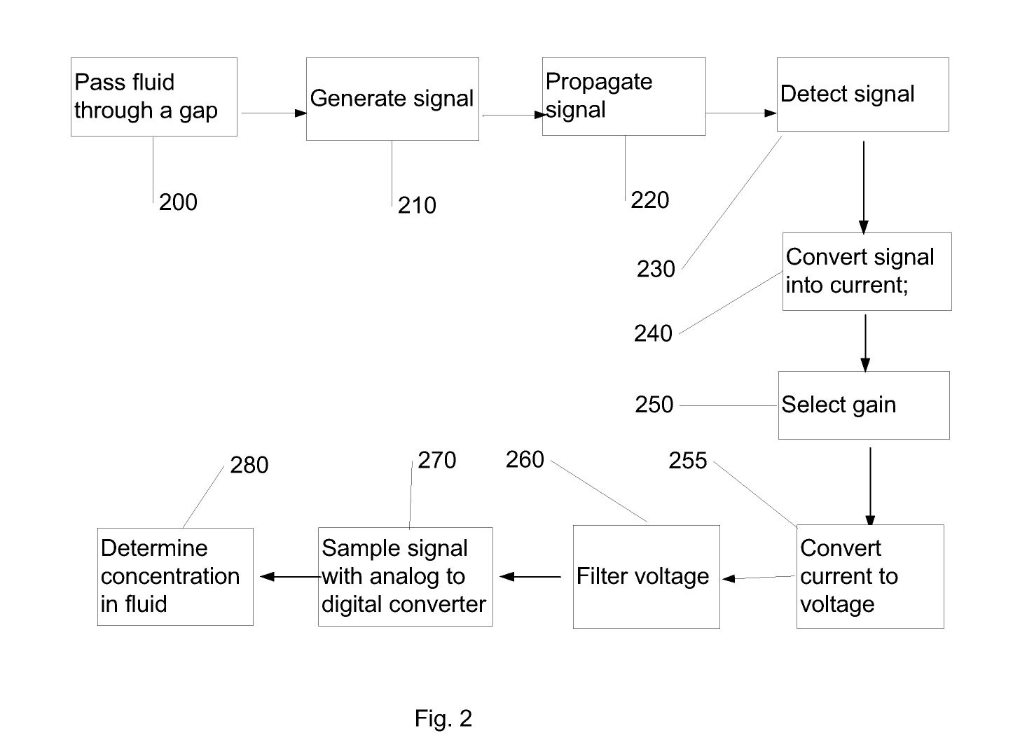

FIG. 2 is a flow diagram of a method for calculating the concentration of solids in a liquid of a fluid, according to an example.

Fluid 60 may typically be passed through gap 50 as depicted by box 200.

A signal 5, typically light, configured to be defined as a sine wave at a predefined frequency, is generated by light source 10 as depicted by box 210.

Signal 5 from light source 10 is propagated through any fluid 60 in gap 50 as depicted by box 220. In some examples there may not be fluid in gap 50. Typically, signal is attenuated as it is propagated through fluid 60. Typically the attenuation of signal 5 as it is propagated through fluid 60 is indicative of the characteristics of fluid 60 as determinably by look-up table 110.

Signal 5 may be detected by detector 40 as depicted by box 230.

Signal frequency may be converted into a corresponding current that is fed into an amplifying device as are known in the art with a selectable gain, as depicted by box 240. Typically light source 10 is limited in the amount and magnitude of the signal sent to detector 40. In some examples, the gain can be adjusted such that it amplifies the signal from light source 10 after the signal has been propagated through fluid 60.

Processor 90 typically selects the gain based on information regarding pigment color and information from look-up table 110, as depicted by box 250.

The current may then be converted into a voltage, as is depicted by box 255.

The signal, now converted into a voltage, e.g., a voltage signal, from attenuated signal from light source 10 is then filtered by a narrow band filter that is synchronized to the same predefined frequency as signal 5 from light source 10, as depicted by box 260. In some applications, densitometer 100 may be configured to seek out only the positive components of the signal, when the signal is a wave, the signal coming from light source 10 and traveling through fluid 60; e.g., when the signal is a wave with both positive and negative components. In some examples, densitometer 100 is configured to subtract the negative components of the signal, by calculations known in the art.

The received signal 7 may then be sampled by analog to digital converter 120, by calculations as are know in the art, as depicted by box 270, creating a digital signal. Analog to digital converter typically has a digital filter for improving the dynamic range of detector 40 or to limit noise.

Typically, densitometer 100 determines the % NVS of fluid 60 given signal 7, as depicted by box 280, by calculations known in the art. In some examples densitometer 100 determines the optical density of fluid 60 given signal 7, as depicted by box 280. In some examples, densitometer 100 determines other characteristics of fluid 60, given signal 7, as depicted by box 280.

In some examples, densitometer 100 may include a non-transitory computer readable medium containing instructions to carry out one or a plurality of the aforementioned steps.

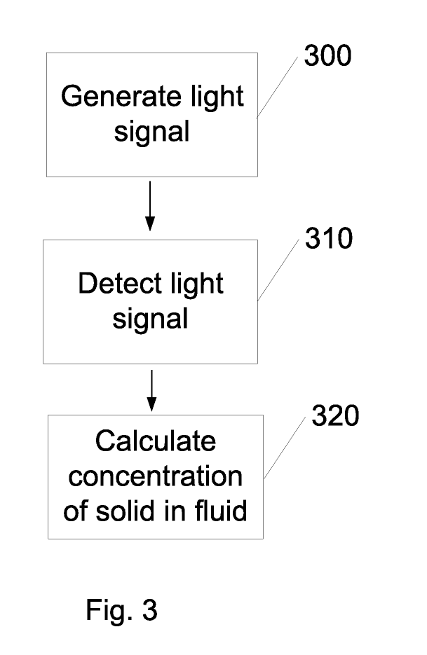

FIG. 3 is a flow diagram of a method to calculate a concentration of solids in a fluid according to an example.

Typically light source 10, in some examples a laser generates a light signal of predefined characteristics as depicted by box 300. The characteristics of the generated light signal, in some examples may be communicated to processor 90.

In some examples, detector 40, typically, an optical detector, which may be placed opposite light source 10 across gap 50 between at least light source 10 and detector 40 through which fluid 60 detects signal 5, typically a light signal, as depicted by box 310.

Typically, a processor identifies the light signal within a detection signal generated by detector 40 and calculates the concentration of solids, in some examples the % NVS, of fluid 60, based on the identified light signal as it is related to the generated light signal, as depicted by box 320.

Features of various examples discussed herein may be used with other embodiments discussed herein. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A system to calculate a concentration of solids in a fluid, the system comprising:
a light source to generate a modulated light signal of predefined characteristics;
an optical detector, placed opposite the light source across a gap between the light source and the detector through which the fluid may flow;
a processor to:
identify the light signal in a detection signal generated by the optical detector and calculate the concentration of solids in the fluid based on an identified light signal as related to a generated light signal.

2. The system of claim 1, wherein the processor further comprises a filter synchronized to one or a plurality of predefined characteristics of the light signal.

3. The system of claim 1, wherein the system further comprises a current to voltage converter with a selectable gain to convert the detection signal into a voltage.

4. The system of claim 1, wherein the system further comprises an analog to digital converter to sample the voltage.

5. The system of claim 1, wherein the system a further comprises a look-up table to convert the voltage into a value reflecting a concentration of a solid in the fluid.

6. The system of claim 1, wherein the processor is configured to predefine the light signal to have the characteristics of a sine wave with a frequency of one kilohertz.

7. A method to calculate a concentration of solids in a fluid, the method comprising:
modulating a light source to generate a light signal of predefined characteristics by a light source;
detecting the light signal by an optical detector, placed opposite the light source across a gap between the light source and the detector through which the fluid is passed;
identifying the light signal in a detection signal generated by the optical detector and calculating the concentration of solids in the fluid based on an identified light signal as related to a generated light signal, using a processor.

8. The method of claim 7, wherein the processor filters the detected signal for one or a plurality of predefined characteristics of the light signal.

9. The method of claim 7, wherein the method further comprises converting the detection signal into a voltage signal via a current to voltage convertor with a selectable gain.

10. The method of claim 7, wherein the method further comprises converting the detected signal into a digital signal via an analog to digital converter.

11. The method of claim 7, wherein the method further comprises referencing a look-up table to convert the signal into a value reflecting a concentration of a solid in the fluid.

12. The method of claim 7, wherein the processor predefines the light signal to have the characteristics of a sine wave with a frequency of one kilohertz.

13. A non-transitory computer readable medium to calculate a concentration of solids in a fluid, comprising instructions, which when executed cause a processor to:
identify a modulated light signal of predefined characteristics that is generated by a light source in a detection signal generated by an optical detector placed opposite the light source across a gap between the light source and the detector through which the fluid is passed; and
calculate the concentration of solids in the fluid based on the identified light signal as related to the generated light signal, using a processor.

14. The non-transitory computer readable medium of claim 6, further comprising instructions, which when executed, causes a processor to cause the light source to generate the light signal with predefined characteristics.

15. The non-transitory computer readable medium of claim 6, further comprising instructions which when executed, causes a processor to cause the light source to generate a light signal, the light signal having the characteristics of a sine wave with a frequency of one kilohertz.
